(19) United States
(12) Patent Application Publication
(10) Pub. No.: US 2012/0262638 A1
(43) Pub. Date: Oct. 18, 2012

(54) STEREOSCOPIC IMAGE DISPLAYS

(75) Inventor: Eddy Giing-Lii CHEN, Miao-Li County (TW)

(73) Assignees: CHIMEI INNOLUX CORPORATION, Miao-Li County (TW); INNOCOM TECHNOLOGY (SHENZHEN) CO., LTD., Shenzhen City (TW)

(21) Appl. No.: 13/446,989

(22) Filed: Apr. 13, 2012

(30) Foreign Application Priority Data
Apr. 14, 2011 (TW) 100112927

(51) Int. Cl. G02F 1/1335

(52) U.S. Cl. 349/15

(57) ABSTRACT

Disclosed is a stereoscopic image display, including a liquid crystal display and a patterned retarder color filter structure disposed on the outside of the liquid crystal display. The liquid crystal display has a left eye image control region and a right eye image control region. The patterned retarder color filter structure has a right eye image retarder region substantially vertically aligning with the right eye image control region, and a left eye image retarder region substantially vertically aligning with the left eye image control region.

### CROSS REFERENCE TO RELATED APPLICATIONS

This Application claims priority of Taiwan Patent Application No. 100112927, filed on Apr. 14, 2011, the entirety of which is incorporated by reference herein.

### BACKGROUND OF THE INVENTION

1. Field of the Invention

The present disclosure relates to stereoscopic image displays, and in particular relates to a patterned retarder color filter structure thereof.

2. Description of the Related Art

Stereoscopic image displays will be a trend in the future. The concept incorporates the idea that a right eye and left eye of a user see different images, respectively. For example, an array substrate of a stereoscopic image display including a retarder film can be divided to right eye image control regions and left eye image control regions. The polarized angle of the right eye image control regions is tuned to be vertical to the polarized angle of the left eye image control regions by the retarder film. Through a passive retarder glass, the right eye of the user only sees right eye images from the right eye image control regions, and the left eye of the user only sees left eye images from the left eye image control regions, respectively. The right and left eye images are combined by the brain of a user to produce a perfect stereoscopic visual effect.

FIG. 1 is a schematic view showing a stereoscopic image display in related arts. Images are firstly polarized by a retarder film 11 to form linear polarized images having a phase of 135°, and then polarized by a patterned retarder film 13. The patterned retarder film 13 can be divided into left eye image retarder regions 13A (e.g. a quarter wave retarder film has a phase shift of 90° and right eye image retarder regions 13B (e.g. a quarter wave retarder film has a phase shift of 0°. The linear polarized images are polarized to left-handed polarized images 15A by the left eye image retarder regions 13A, and polarized to right-handed polarized images 15B by the right eye image retarder regions 13B. Because the passive retarder glass 17 has a quarter wave retarder film 17C, the left-handed polarized images 15A travelling through the quarter wave retarder film 17C are polarized to form linear polarized images having a phase shift of 45°, and the right-handed polarized images 15B travelling through the quarter wave retarder film 17C are polarized to form linear polarized images having a phase shift of 135°. The left glass 17A is a linear retarder film and has a phase shift of 45°, and the right glass 17B is a linear retarder film and has a phase shift of 135°. As such, the left eye only sees the linear polarized images having a phase shift of 45° from the left eye image retarder regions 13A, and the right eye only sees the linear polarized images having a phase shift of 135° from the right eye image retarder regions 13B, respectively.

FIG. 2 is a cross sectional view of a stereoscopic image display 200 in related art. The stereoscopic image display 200 includes a liquid crystal display 20 and a patterned retarder film 29. The liquid crystal display 20 includes a backlight unit 21, a back side retarder film 22, an array substrate 23, a liquid crystal layer 24, a color filter substrate 25, and a front side retarder film 27. Generally, the array substrate 23 has a plurality of pixel regions (such as right eye image control regions 23R and left eye image control regions 23L) substantially vertically aligning with color filter regions 25R, 25G, and 25B of different colors on the color filter substrate 25. A patterned retarder film 29 including right eye image retarder regions 29R and left eye image retarder regions 29L is disposed on the outside of the liquid crystal display 20. The right eye image retarder regions 29R substantially vertically align with the right eye image control regions 23R, and the left eye image retarder regions 29L substantially vertically align with the left eye image control regions 23L, respectively. In general, if all of the light beams from the backlight unit 21 are similar to the light beam 28 vertically travelling through the left eye image control regions 23L (or the right eye image control regions 23R), the liquid crystal layer 24, the color filter regions 25G (or 25R/25B) of the color filter substrate 25, and left eye image retarder regions 29L (or the right eye image retarder regions 29R), a user may see correct stereoscopic images. However, the backlight unit 21 must radiate non-vertical light beams such as the light beam 28′. The light beam 28′ which is inclined and traveling through the right eye image control regions 23R of the array substrate 23, the liquid crystal layer 24, and the color filter region 25B of the color filter substrate 25 will travel through the left eye image retarder region 29L. Accordingly, a so-called crosstalk may occur, wherein an eye of a user may see unintended images due to the inclined light beam 28′.

Some skilled in the art utilize black stripes 31 as shown in FIG. 3 to prevent the crosstalk problem as shown in FIG. 2. The black stripes 31 are located between the right eye image retarder regions 29R and the left eye image retarder regions 29L of the patterned retarder film 29. As shown in FIG. 3, the black stripe 31 should be wider than the black matrixes BM between the color filter regions 23R, 23G, and 23B, such that the inclined light beam 28′ can be shielded, and the vertical light beam 28 will not be interfered by the inclined light beam 28′. However, the black stripes 31 not only shields the inclined light beam 28′, but also shields a part of the vertical light beam 28, as shown in FIG. 3. On the other hand, if the light beams have greater inclined degrees such as the light beam 28″, the black stripes 31 will fail to shield the inclined light beam. In other words, the crosstalk problem due to the inclined light beam cannot be solved by the black stripes 31.

Accordingly, a novel stereoscopic image display is called for to solve the crosstalk problem.

### BRIEF SUMMARY OF THE INVENTION

One embodiment of the disclosure provides a stereoscopic image display, comprising: a liquid crystal display having a left eye image control region and a right eye image control region; and a patterned retarder color filter structure of multi-colors disposed on the outside of the liquid crystal display, wherein the patterned retarder color filter structure has a right eye image retarder region and a left eye image retarder region, and the right eye image retarder region substantially vertically aligns with the right eye image control region, and the left eye image retarder region substantially vertically aligns with the left eye image control region.

A detailed description is given in the following embodiments with reference to the accompanying drawings.

### BRIEF DESCRIPTION OF THE DRAWINGS

The present disclosure can be more fully understood by reading the subsequent detailed description and examples with references made to the accompanying drawings, wherein:

FIG. 1 is a schematic view showing a stereoscopic image display in related arts;

FIGS. 2-3 are cross sectional views of stereoscopic image displays in related art;

FIGS. 4A-4C is a cross sectional view of a stereoscopic image display in one embodiment of the disclosure;

FIGS. 5A-5D are top views of color filter region arrangements in a color filter layer of the color filter substrate, a color filter layer of a patterned retarder color filter structure, or a dyed patterned retarder film in embodiments of the disclosure;

FIGS. 6A-6D are top views of right and left eye image control region arrangements in an array substrate, a retarder film, and a patterned retarder color filter structure in embodiments of the disclosure; and

FIG. 7 is a cross sectional view of a stereoscopic image display in one embodiment of the disclosure.

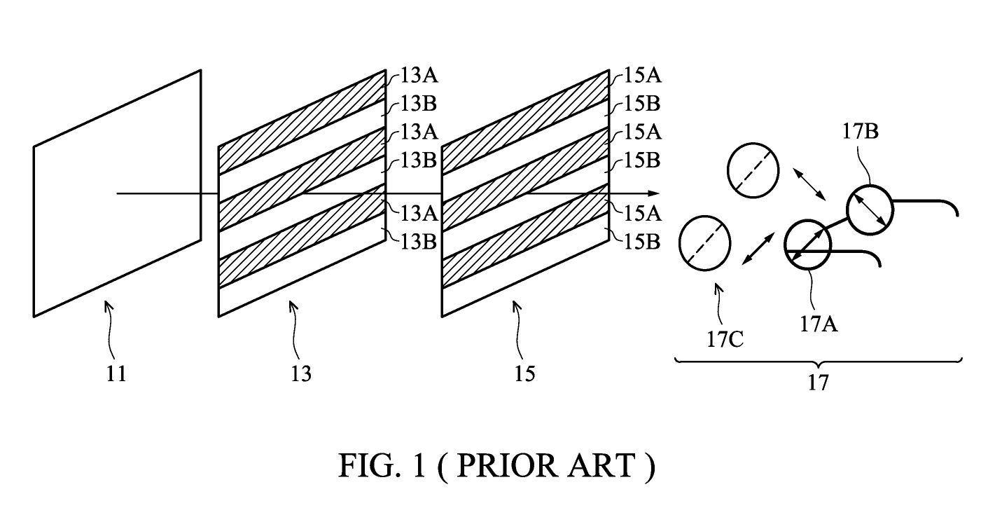

### DETAILED DESCRIPTION OF THE INVENTION

The following description is of the best-contemplated mode of carrying out the disclosure. This description is made for the purpose of illustrating the general principles of the disclosure and should not be taken in a limiting sense. The scope of the disclosure is best determined by reference to the appended claims.

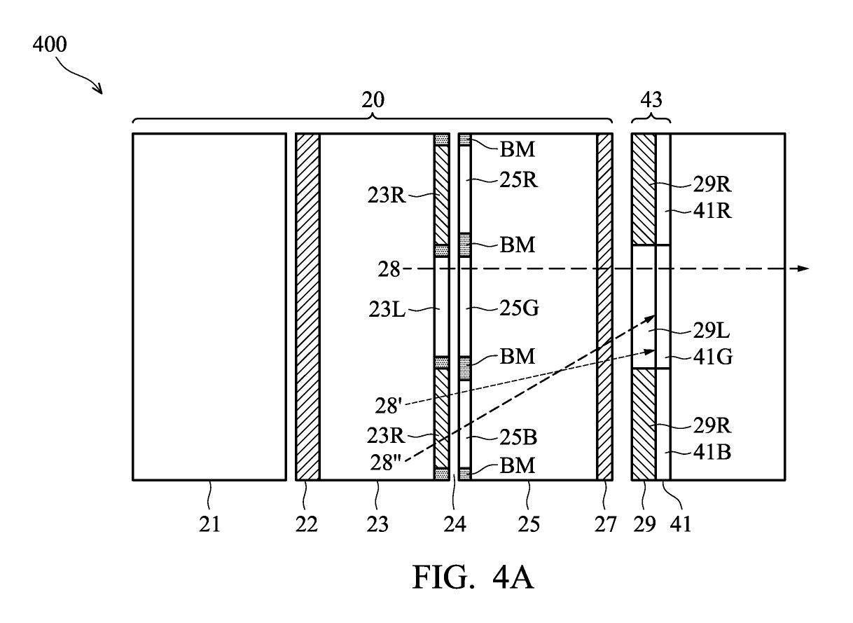

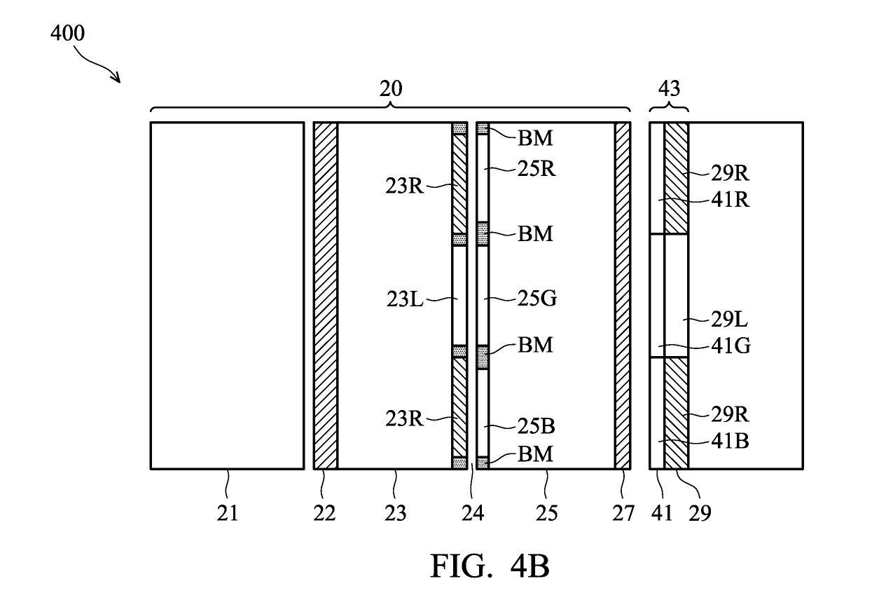

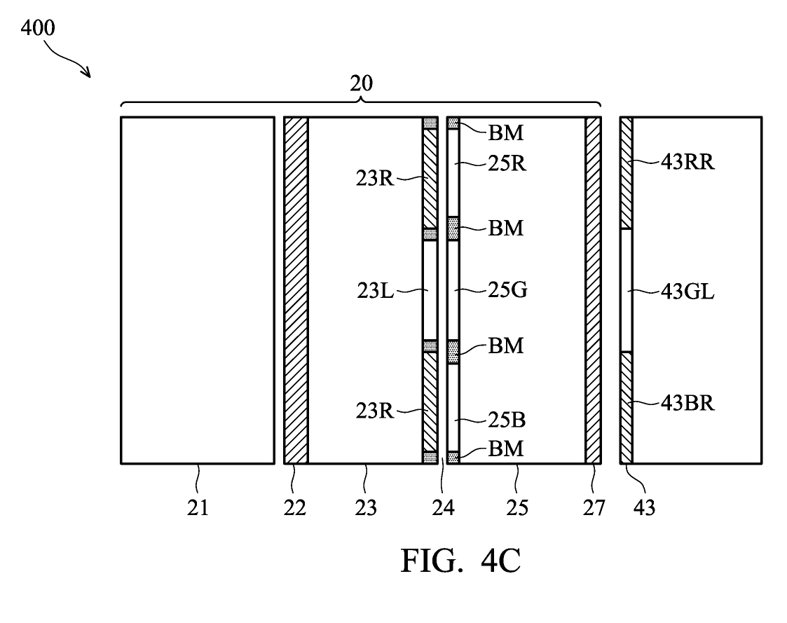

The stereoscopic image display 400 of the disclosure can be applied to all liquid crystal displays (LCD), including but not limited to a conventional LCD 20. In one embodiment, the patterned retarder color filter structure 43 includes a color filter layer 41 and a patterned retarder film 29, wherein the color filter layer 41 is disposed on the outside of the patterned retarder film 29. In other words, the patterned retarder film 29 is disposed between the color filter film 41 and the color filter substrate 25, as shown in FIG. 4A. Red color filter regions 41R of the color filter layer 41 substantially vertically align with the red color filter regions 25R of the color filter substrate 25, green color filter regions 41G of the color filter layer 41 substantially vertically align with the green color filter regions 25G of the color filter substrate 25, and blue color filter regions 41B of the color filter layer 41 substantially vertically aligns with the blue color filter regions 25B of the color filter substrate 25. As such, the inclined light beam 28′ travelling through the right eye image control region 23R of the array substrate 23, the liquid crystal layer 24, the blue color filter region 25B of the color filter substrate 25, and the left image retarder region 29L is shielded by the green color filter region 41G of the color filter layer 41. Even if the light beam has a large inclined degree, e.g. the light beam 28″, the largely inclined light beam is shielded by the green color filter region 41G, too. Note that the color filter regions 41R, 41G, and 41B of the color filter layer 41 have no additional black stripe therebetween, such that part of the vertical light beam 28 will not be shielded. Therefore, the patterned retarder color filter structure of the embodiment may efficiently solve the crosstalk problem. Because the black stripe which reduces the image brightness is omitted, the visual resolution is largely improved.

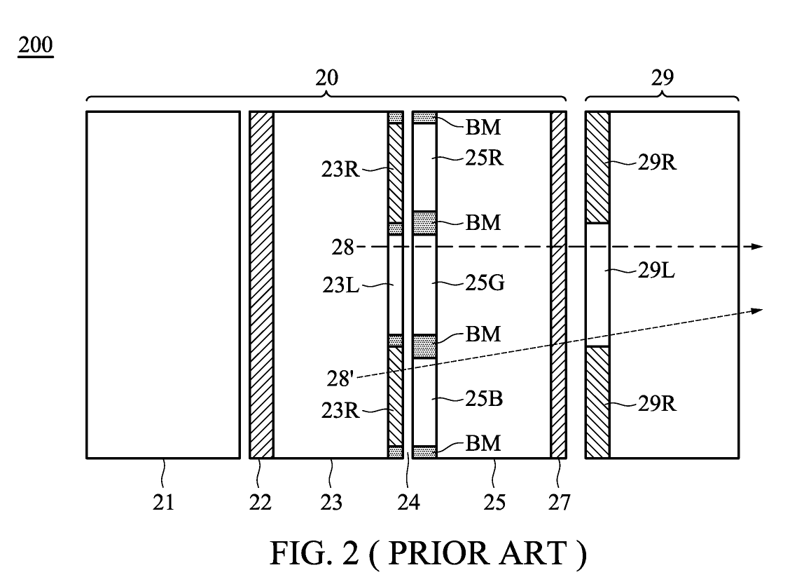

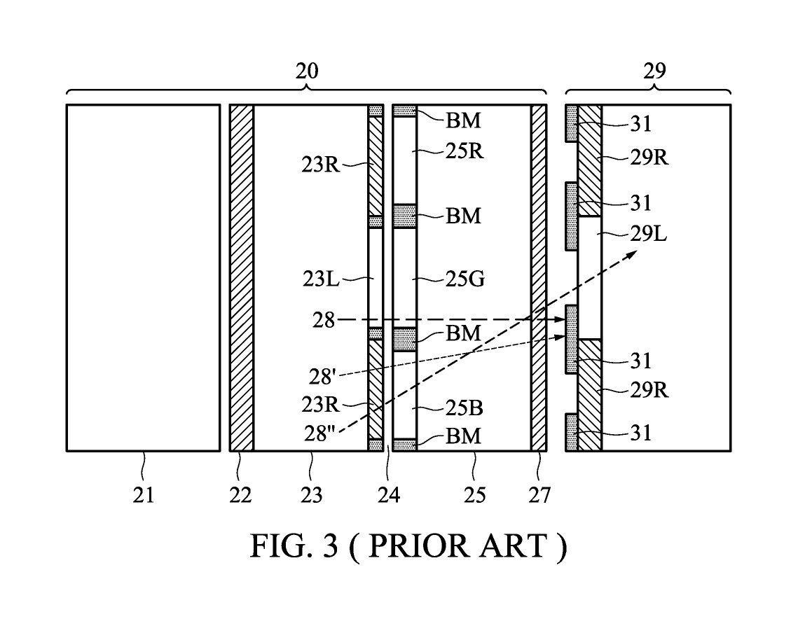

In another embodiment, the color filter layer 41 is disposed on the inside of the patterned retarder film 29. In other words, the color filter 41 is disposed between the patterned retarder film 29 and the color filter substrate 25, as shown in FIG. 4B. Similarly, the patterned retarder color filter structure 43 includes the color filter layer 41 and the patterned retarder film 29. For the color filter layer 41 disposed on the inside or the outside of the patterned retarder film 29, the color filter layer 41 and the color filter layer of the color filter substrate 25 have a preferably total thickness of 2 μm to 3 μm (a general thickness of a color filter layer in a common LCD). For example, if the color filter layer of the color filter substrate 25 in FIG. 2 has a preferable thickness of 3 μm, the color filter layer 41 and the color filter layer of the color filter substrate 25 will have a total thickness of 3 μm, such that image brightness is not reduced. Note that the color filter layer 41 and the color filter layer of the color filter substrate 25 preferably have a same thickness such as 1.5 μm.

In a further embodiment, the patterned retarder film is directly dyed to form the patterned retarder color filter structure 43, as shown in FIG. 4C. The patterned retarder color filter structure 43 includes a plurality of retarder color filter regions 43RR (right eye image retarder regions dyed of red), 43GL (left eye image retarder regions dyed of green), and 43BR (right eye image retarder regions dyed of blue) of multi-colors. For the color filter substrate 25, the red retarder color filter regions 43RR substantially vertically aligns with the red color filter regions 25R, the green retarder color filter regions 43GL substantially vertically aligns with the green color filter regions 25G, and blue retarder color filter regions 43BR substantially vertically aligns with the blue color filter regions 25B. For the array substrate 23, the retarder color filter regions 43RR and 43BR for right eye images traveling therethrough, substantially vertically align with the right eye image control region 23R, and the retarder color filter regions 43GL for left eye images traveling therethrough, substantially vertically align with the left eye image control region 23L. It should be understood that the retarder color filter regions for the right eye images traveling therethrough, are not only limited to be dyed of red and/or blue colors, but may also be dyed of other combinations of colors. Similarly, the retarder color filter regions for the left eye images traveling therethrough, are not only limited to be dyed of green colors, but may also be dyed of other combinations of colors.

As described above, the dyed patterned retarder film and the color filter layer of the color filter substrate 25 have a preferably total thickness of 2 μm to 4.5 μm, wherein the dyed patterned retarder film preferably has a thickness of about 1.5 μm to 3 μm, and the dyed patterned retarder film is preferably thicker than that of the color filter layer of the color filter substrate 25.

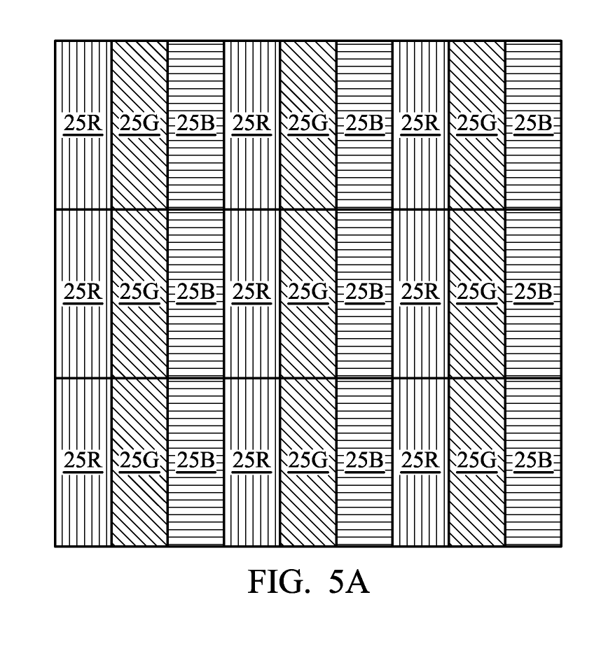

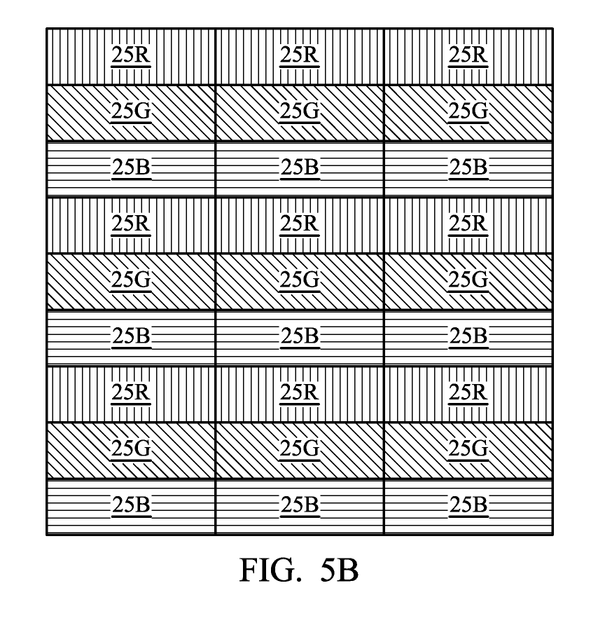

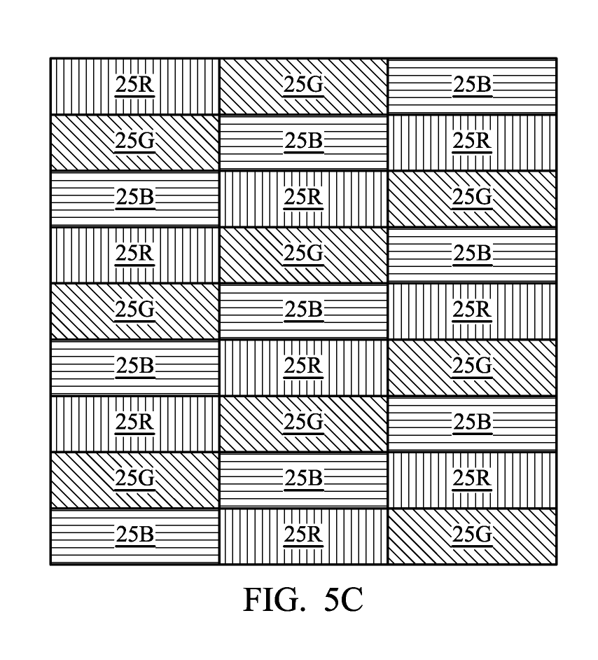

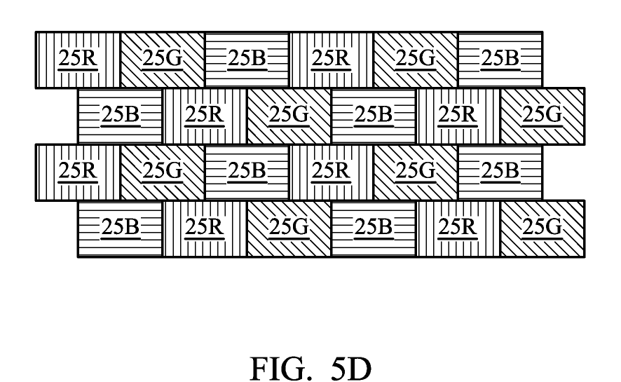

The color filter regions 25R, 25G, and 25B of the color filter substrate 25 can be arranged in several manners, as shown in FIGS. 5A-5D. Note that the color filter regions in FIGS. 5A-5D are only dyed of general colors such as red, blue, and green, however, color filter regions dyed of other colors such as cyan, yellow, pink, or other colors can be applied to the stereoscopic image displays of the disclosure. In addition, the color filter regions 25R, 25G, and 25B can be separated by black matrixes BM, as shown in FIGS. 4A-4C. It should be understood that the color filter layer 41 or retarder color filter regions of the dyed patterned retarder film must have the same arrangements as the color filter regions of the color filter substrate 25. If so, then the color filter regions of the color filter layer 41 (or retarder color filter regions of the dyed patterned retarder film) and the color filter regions of the color filter substrate 25 of the same color will substantially vertically align with each other. Compared with the color filter substrate 25, the color filter regions of the color filter layer 41 (or the dyed patterned retarder film) have no black stripe therebetween to avoid reducing image brightness.

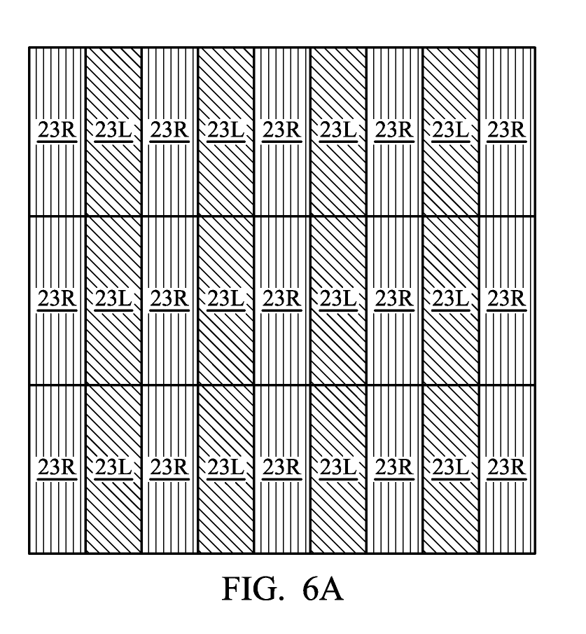

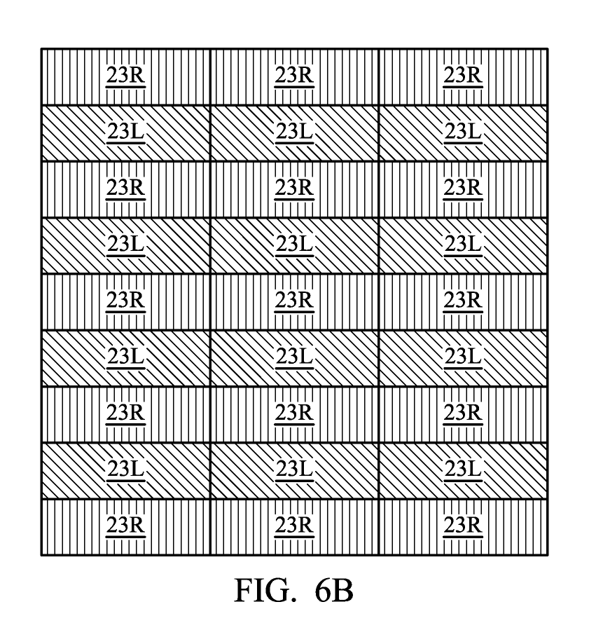

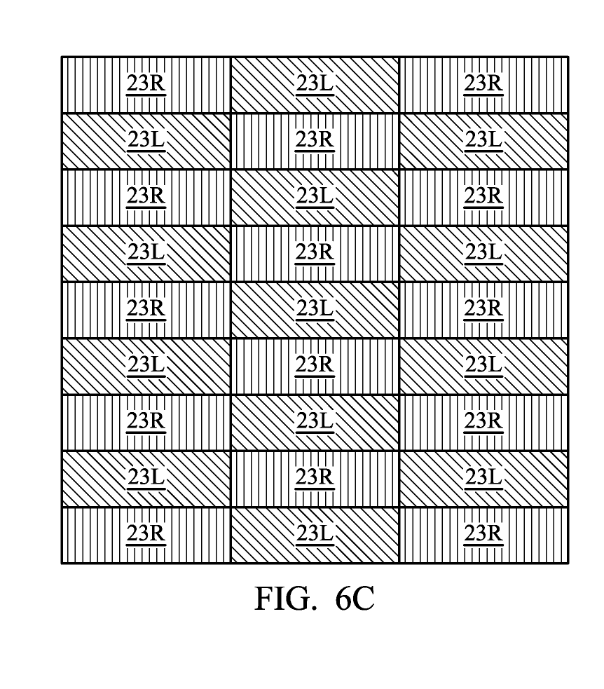

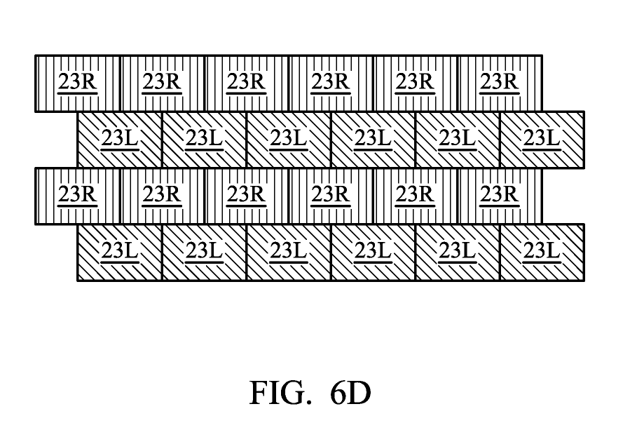

The right eye image control region 23R and the left eye image control region 23L of the array substrate 23 can be arranged in several manners, as shown in FIGS. 6A-6D. Note that the arrangement of the image control regions in FIG. 6A should collocate with the arrangement of the color filter regions in FIG. 5A, the arrangement of the image control regions in FIG. 6B should collocate with the arrangement of the color filter regions in FIG. 5B, the arrangement of the image control regions in FIG. 6C should collocate with the arrangement of the color filter regions in FIG. 5C, and the arrangement of the image control regions in FIG. 6D should collocate with the arrangement of the color filter regions in FIG. 5D. It should be understood that the right eye image retarder regions 29R and the left eye image retarder regions 29L of the patterned retarder film 29 must have the same arrangements as the right eye image control regions 23R and the left eye image control regions 23L of the array substrate 23. As such, the right eye image control region 23R may substantially vertically align with the right eye retarder regions 29R, and the left eye image control regions 23L may substantially vertically align with the left eye retarder regions 29L, respectively. Similarly, the right eye image retarder color filter regions (e.g. 43RR and 43BR) and the left eye image retarder color filter regions (e.g. 43GL) of the dyed patterned retarder film must have the same arrangements as the right eye image control regions 23R and the left eye image control regions 23L of the array substrate 23.

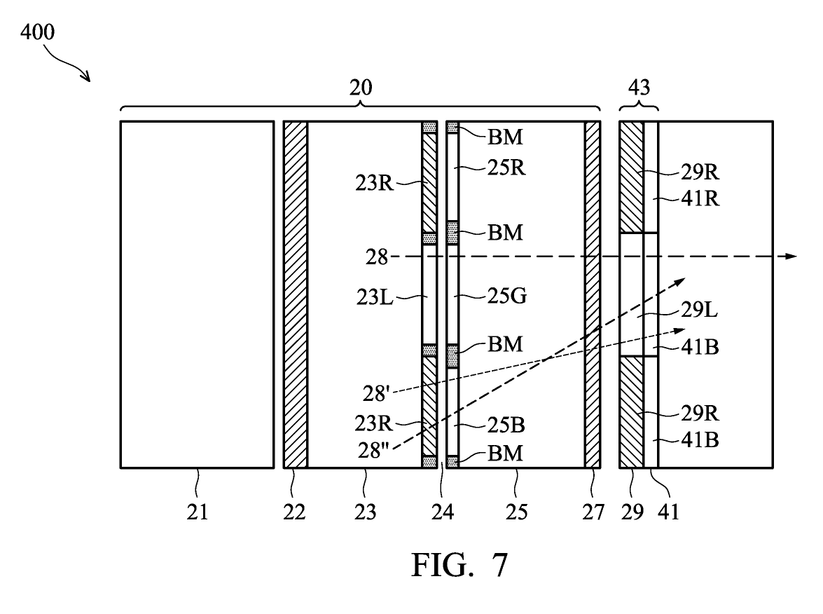

The arrangement of the image control regions in FIG. 6A and the arrangement of the color filter regions in FIG. 5A are common arrangements. The dark line of the disclosure is less obvious than that of the related arts. One retarder region corresponds to several sub-pixels (e.g. image control regions) in related arts, but one retarder region only corresponds to one sub-pixel (e.g. image control region) in the disclosure. Accordingly, the arrangements in FIGS. 6A-6D may efficiently reduce the dark line problem. The arrangement in FIG. 6A limits the horizontal viewing angle, and the arrangement in FIG. 6B limits the vertical viewing angle. Although the arrangement in FIGS. 6C or 6D limit horizontal and vertical viewing angles, it has better viewing angles in average. Because the image control regions in FIG. 6B and the image control regions in FIG. 6A have a width ratio of 3:1, the visual effect of the dark line in FIG. 6B is less obvious than that of the FIG. 6A. The color filter regions are arranged in a cheeseboard like fashion, as shown in FIG. 5C, and the color filter regions are arranged in a brick wall like fashion, as shown in FIG. 5D. In the arrangements of FIG. 5C (or FIG. 5D) corresponding to FIG. 6C (or FIG. 6D), the adjacent color filter regions substantially vertically aligning with the adjacent right and/or left eye image control regions 29R and/or 29L, have different colors. If the adjacent color filter regions have the same color, the inclined light beams 28′ or 28″ traveling through the right image control region 23R, the liquid crystal layer 24, the color filter region 25B of the color filter substrate 25, and the left eye image retarder region 29L will still travel through the color filter region 41B to produce crosstalk, as shown in FIG. 7.

While the disclosure has been described by way of example and in terms of the preferred embodiments, it is to be understood that the disclosure is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A stereoscopic image display, comprising:
a liquid crystal display having a left eye image control region and a right eye image control region; and
a patterned retarder color filter structure of multi-colors is disposed on the outside of the liquid crystal display,
wherein the patterned retarder color filter structure has a right eye image retarder region and a left eye image retarder region, and the right eye image retarder region substantially vertically aligns with the right eye image control region, and the left eye image retarder region substantially vertically aligns with the left eye image control region.

2. The stereoscopic image display as claimed in claim 1, wherein
the liquid crystal display has a color filter layer having first color filter regions of multi-colors;
the patterned retarder color filter structure is a dyed patterned retarder film having second color filter regions of multi-colors; and
the first and second color filter regions of the same color substantially vertically align with each other.

3. The stereoscopic image display as claimed in claim 2, wherein the color filter layer and the dyed patterned retarder film have a total thickness of 2 μm to 4.5 μm.

4. The stereoscopic image display as claimed in claim 2, wherein the dyed patterned retarder film is thicker than the color filter layer.

5. The stereoscopic image display as claimed in claim 2, wherein the adjacent first color filter regions substantially vertically aligning with the adjacent right and/or left eye image control regions have different colors, and the adjacent second color filter regions substantially vertically aligning with the adjacent right and/or left eye image retarder regions have different colors.

6. The stereoscopic image display as claimed in claim 2, wherein the second color filter regions have no black matrix therebetween.

7. The stereoscopic image display as claimed in claim 1, wherein
the liquid crystal display has a first color filter layer having first color filter regions of multi-colors;
the patterned retarder color filter structure is a stack structure of a patterned retarder film and a second color filter layer having second color filter regions of multi-colors; and
the first and second color filter regions of the same color substantially vertically align with each other.

8. The stereoscopic image display as claimed in claim 7, wherein the first color filter layer and the second color filter layer have a total thickness of 2 μm to 3 μm.

9. The stereoscopic image display as claimed in claim 7, wherein the first color filter layer and the second color filter layer have a same thickness.

10. The stereoscopic image display as claimed in claim 7, wherein the adjacent first color filter regions substantially vertically aligning with the adjacent right and/or left eye image control regions have different colors, and the adjacent second color filter regions substantially vertically aligning with the adjacent right and/or left eye image retarder regions have different colors.

11. The stereoscopic image display as claimed in claim 7, wherein the second color filter regions have no black matrix therebetween.
